(19) United States
(12) Patent Application Publication
(10) Pub. No.: US 2025/0153667 A1
(43) Pub. Date: May 15, 2025

(54) MANAGEMENT DEVICE

(71) Applicant: TOYOTA JIDOSHA KABUSHIKI KAISHA, Toyota-shi (JP)

(72) Inventors: Shingo TOMIDA, Toyota-shi (JP); Daisuke TAKAISHI, Toyota-shi (JP); Kazuya SUGIYAMA, Toyota-shi (JP); Hiroya ANDOU, Toyota-shi (JP)

(73) Assignee: TOYOTA JIDOSHA KABUSHIKI KAISHA, Toyota-shi (JP)

(21) Appl. No.: 18/939,628

(22) Filed: Nov. 7, 2024

(30) Foreign Application Priority Data
Nov. 13, 2023 (JP) 2023-193077

(51) Int. Cl. B60R 16/03; B60R 16/023; H04L 12/40

(52) U.S. Cl. CPC B60R 16/03; B60R 16/0232; H04L 12/40039; H04L 2012/40273

(57) ABSTRACT

A management device for a vehicle on-board network system includes processing circuitry that starts a target device that operates in accordance with a predetermined function to be executed. Subsequent to modifications made to the vehicle on-board network system, the processing circuitry obtain information including a first startup power consumption and a second startup power consumption. The first startup power consumption is required when using a first startup method for controlling whether to supply power to the target device. The second startup power consumption is required when using a second startup method for communicating with the target device to request startup for the target device. The processing circuitry selects a startup method for the target device from the first startup method and the second startup method based on the obtained information, and start the target device using the selected startup method.

### CROSS-REFERENCE TO RELATED APPLICATIONS

This application is based upon and claims the benefit of priority from prior Japanese Patent Application No. 2023-193077, filed on Nov. 13, 2023, the entire contents of which are incorporated herein by reference.

### BACKGROUND

### 1. Field

The present disclosure relates to a management device.

### 2. Description of Related Art

Japanese Laid-Open Patent Publication No. 2017-33321 discloses a power control system. This power control system includes a management device and a target device that is started by the management device. The management device starts the target device through power control.

Japanese Laid-Open Patent Publication No. 2021-11228 discloses a vehicle on-board network system. In this vehicle on-board network system, the management device communicates with the target device to request its startup, thereby starting the target device.

It is proposed to use the above-described two startup methods selectively. In a case in which modifications have been made to the vehicle on-board network system (e.g., adding a target device), the same startup method as the one that was employed prior to the modifications may not necessarily be optimal for the vehicle on-board network system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A management device according to an aspect of the present disclosure is a management device for a vehicle on-board network system in which devices are connected in a communicable manner. The management device includes processing circuitry configured to start a target device of the devices, the target device being a device that operates in accordance with a predetermined function to be executed. The processing circuitry is configured to, subsequent to modifications made to the vehicle on-board network system, obtain information including: a first startup power consumption required when starting the target device using a first startup method for starting the target device through power control that controls whether to supply power to the target device; and a second startup power consumption required when starting the target device using a second startup method for starting the target device by communicating with the target device to request startup for the target device. The processing circuitry is configured to, based on the obtained information, select a startup method for the target device from the first startup method and the second startup method. The processing circuitry is configured to start the target device using the selected startup method.

Other features and aspects will be apparent from the following detailed description, the drawings, and the claims.

### BRIEF DESCRIPTION OF THE DRAWINGS

FIG. 1 is a schematic diagram showing the configuration of a vehicle on-board network system including a management device according to an embodiment.

FIG. 2 is a flowchart illustrating the flow of processes related to the learning process executed by the management device shown in FIG. 1.

FIG. 3 is a flowchart illustrating the flow of processes related to the startup of the target device executed by the management device shown in FIG. 1.

FIG. 4 is a table illustrating information related to power consumption required when starting the target device, the information being obtained by the management device of FIG. 1 through the learning process.

FIG. 5 is a table illustrating an example of the startup method for the target device for each bus network, the method being selected by the management device in FIG. 1 through the learning process.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

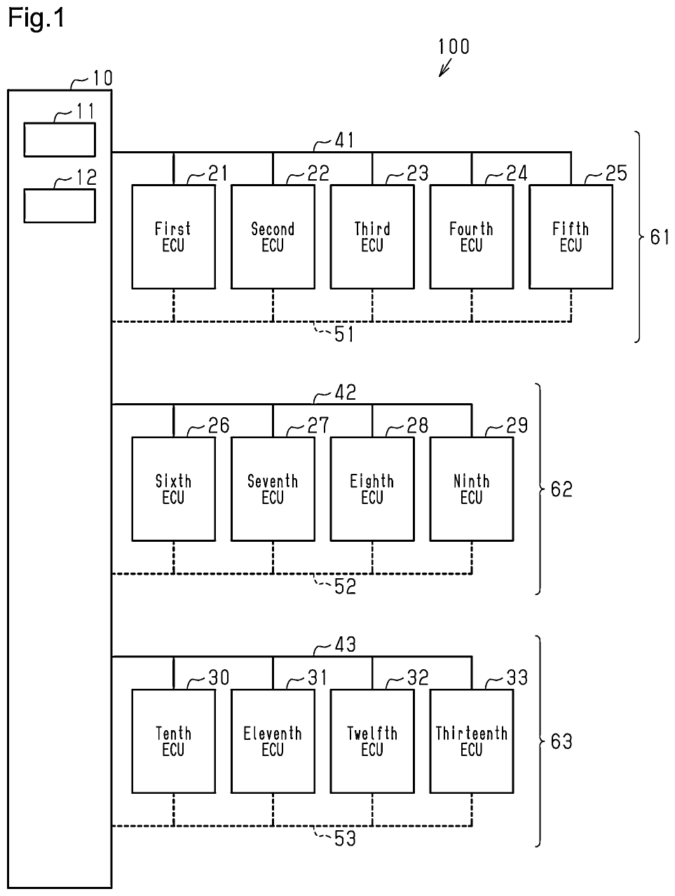

An embodiment of a management device will now be described with reference to FIGS. 1 to 5.

### Configuration of Vehicle On-Board Network System 100

As shown in FIG. 1, the vehicle on-board network system 100 includes electronic control units (ECUs). In FIG. 1, each ECU is depicted as a rectangle. The ECUs are connected to each other via a first communication line 41, a second communication line 42, and a third communication line 43 such that the units can communicate with each other. Thus, the ECUs form a vehicle on-board network. Each ECU is supplied with power from a power source. The ECU alternates between an active state, where processing can be performed, and a standby state, where operation is paused to reduce power consumption.

As shown in FIG. 1, one of the ECUs that form the vehicle on-board network is a management device 10. The management device 10 is connected to other ECUs that form the vehicle on-board network via the first communication line 41, the second communication line 42, and the third communication line 43 such that the units can communicate with each other. Specifically, the management device 10 is directly connected to a first ECU 21, a second ECU 22, a third ECU 23, a fourth ECU 24, and a fifth ECU 25 via the first communication line 41. The management device 10 is directly connected to a sixth ECU 26, a seventh ECU 27, an eighth ECU 28, and a ninth ECU 29 via the second communication line 42. The management device 10 is directly connected to a tenth ECU 30, an eleventh ECU 31, a twelfth ECU 32, and a thirteenth ECU 33 via the third communication line 43.

As indicated by the broken lines in FIG. 1, the management device 10 is also connected to other ECUs forming the vehicle on-board network via a first power control line 51, a second power control line 52, and a third power control line 53. Specifically, the management device 10 is directly connected to the first ECU 21, the second ECU 22, the third ECU 23, the fourth ECU 24, and the fifth ECU 25 via the first power control line 51. The management device 10 is directly connected to the sixth ECU 26, the seventh ECU 27, the eighth ECU 28, and the ninth ECU 29 via the second power control line 52. The management device 10 is directly connected to the tenth ECU 30, the eleventh ECU 31, the twelfth ECU 32, and the thirteenth ECU 33 via the third power control line 53.

In this manner, the management device 10 is connected to the first ECU 21, the second ECU 22, the third ECU 23, the fourth ECU 24, and the fifth ECU 25 via the first communication line 41 and the first power control line 51. As shown in FIG. 1, the first communication line 41, first power control line 51, the first ECU 21, the second ECU 22, the third ECU 23, the fourth ECU 24, and the fifth ECU 25 form a first bus network 61.

The management device 10 is connected to the sixth ECU 26, the seventh ECU 27, the eighth ECU 28, and the ninth ECU 29 via the second communication line 42 and the second power control line 52. As shown in FIG. 1, the second communication line 42, the second power control line 52, the sixth ECU 26, the seventh ECU 27, the eighth ECU 28, and the ninth ECU 29 form a second bus network 62.

The management device 10 is connected to the tenth ECU 30, the eleventh ECU 31, the twelfth ECU 32, and the thirteenth ECU 33 via the third communication line 43 and the third power control line 53. As shown in FIG. 1, the third communication line 43, the third power control line 53, the tenth ECU 30, the eleventh ECU 31, the twelfth ECU 32, and the thirteenth ECU 33 form a third bus network 63.

In this manner, the vehicle on-board network system 100 includes the first bus network 61, the second bus network 62, and the third bus network 63, each connected to the management device 10. The number of bus networks connected to the management device 10 is not limited to three. In other words, the management device 10 may be connected to any number of bus networks. The connection modes for the ECUs, that is, the topology of the vehicle on-board network, are not limited to the same topology as the present embodiment.

As shown in FIG. 1, the management device 10 includes a processing device 11 and a storage device 12. The storage device 12 stores programs. The processing device 11 executes various processes by running the programs stored in the storage device 12. The processing device 11 is processing circuitry that includes one or more processors. The storage device 12 includes a memory such as RAM and ROM.

The management device 10 sends a signal to other ECUs on the vehicle on-board network, requesting them to start, thereby starting those ECUs. Hereinafter, the ECU started by the management device 10 according to a predetermined function executed in the vehicle on-board network system 100 is referred to as the target device. The management device 10 selects and starts multiple target devices necessary to enable functions from multiple ECUs connected to the management device 10 in the vehicle on-board network system 100. The management device 10 transitions the target device from the standby state to the active state by starting the target device. Multiple target devices started by the management device 10 communicate with each other to enable the predetermined function. The combination of target devices to be started varies depending on the functions to be enabled.

In the vehicle on-board network system 100, the first ECU 21 to the thirteenth ECU 33 can be target devices. From these devices, the management device 10 selects and starts the target device according to the function to be enabled each time.

The management device 10 obtains a signal requesting to enable the predetermined function from other devices. For example, the management device 10 receives a signal requesting to enable the predetermined function from other ECUs connected via either the first communication line 41, the second communication line 42, or the third communication line 43.

In this manner, when the management device 10 receives a signal from other devices requesting to enable the predetermined function, the management device 10 designates, as the target device, the device corresponding to the function to be enabled. The management device 10 selects a startup method for the target device from a first startup method and a second startup method. The management device 10 selects the startup method for the target device on each bus network. In other words, the management device 10 uses the same startup method to start the target devices connected to the same bus network. For example, when the target devices corresponding to the function to be enabled are the first ECU 21, the second ECU 22, and the sixth ECU 26, the management device 10 starts the first ECU 21 and the second ECU 22, which are connected to the same bus network, using the same startup method. Since the sixth ECU 26 is connected to a bus network different from that of the first ECU 21 and the second ECU 22, the management device 10 may start the sixth ECU 26 using an startup method different from that of the first ECU 21 and the second ECU 22.

The management device 10 has information regarding which ECU the target device corresponds to and information regarding to which bus network at least one target device is connected. However, the management device 10 does not have information regarding to which bus network each of multiple target devices is connected.

Thus, the management device 10 selects the startup method for the target device based on the bus network for each function to be executed. The management device 10, when enabling a specific function, does not start the ECUs connected to the bus network to which a target device for that function is not connected.

When starting the target device using the first startup method, the management device 10 starts multiple target devices through power control. Specifically, the management device 10 sends a signal requesting the startup of multiple target devices through the power control line. The target device that receives a startup request signal from the management device 10 via the power control line reacts to this signal to receive power. As a result, the target device is started. When the management device 10 sends a signal request startup via the power control line, all ECUs that have received the startup request signal are started. That is, the ECUs directly connected to the management device 10 via the power control line, including ECUs that are not target devices, are all started. Thus, when the management device 10 sends a startup request signal via the first power control line 51, the first ECU 21, the second ECU 22, the third ECU 23, the fourth ECU 24, and the fifth ECU 25 are started. When the management device 10 sends a startup request signal via the second power control line 52, the sixth ECU 26, the seventh ECU 27, the eighth ECU 28, and the ninth ECU 29 are started. When the management device 10 sends a startup request signal via the third power control line 53, the tenth ECU 30, the eleventh ECU 31, the twelfth ECU 32, and the thirteenth ECU 33 are started. Thus, in the first startup method, the management device 10 sends a startup request signal via a power control line to control whether to supply power to the target device.

In this manner, when the management device 10 starts a target device using the first startup method, the management device 10 also starts other ECUs connected to the power control line used to start that target device. Accordingly, the first startup method starts ECUs that are not target devices, and thus consumes excessive power.

To start a target device using the second startup method, the management device 10 sends, via a communication line, a message containing a startup request signal and identification information related to the target device to which the signal will be sent. The management device 10 sends the message to the first ECU 21, the second ECU 22, the third ECU 23, the fourth ECU 24, and the fifth ECU 25 via the first communication line 41. The management device 10 sends the message to the sixth ECU 26, the seventh ECU 27, the eighth ECU 28, and the ninth ECU 29 via the second communication line 42. The management device 10 sends the message to the tenth ECU 30, the eleventh ECU 31, the twelfth ECU 32, and the thirteenth ECU 33 via the third communication line 43.

As the ECU receives the message from the management device 10, it checks the information indicating the recipient contained in the received message. When the ECU that has received the message determines that the message is addressed to the ECU (i.e., determines that the ECU is a target device), the ECU is started according to the received signal. When the ECU that has received the message determines that the message is not addressed to the ECU, the ECU ignores the received signal. In this manner, the management device 10 sends a message via a communication line to start only a target device from multiple ECUs.

Thus, starting a target device using the second startup method prevents an unintended ECU, which is not the target device, from being started. However, in the second startup method, the ECU executes a process that determines whether a startup request signal is addressed to that ECU. As a result, the time required to start the target device is longer than in the first startup method.

As described above, the management device 10 starts a target device via a power control line when using the first startup method and via a communication line when using the second startup method.

Each of the ECUs started by the management device 10 using the first or second startup method sends a signal indicating that the ECU has been started to the management device 10 via the communication line together with the identification information of the sender. This allows the management device 10 to identify the ECU that has been started.

Among the started ECUs, the target devices corresponding to the function to be enabled execute processing while communicating with each other to enable a predetermined function. While enabling the predetermined function in this manner, the target devices each enabling this function periodically send a signal requesting continued operation to the management device 10. While receiving the signal requesting continued operation from the target device, the management device 10 sends a message containing a startup request signal to the target device enabling the function via the communication line.

The target device started by the management device 10 continues to operate for a certain period each time it receives a message addressed to the target device, containing a startup request signal, via the communication line to which the target device is connected. When the target device does not receive a message addressed to the target device, including a startup request signal from the management device 10, via the connected communication line, the target device stops operating and transitions to the standby state.

Accordingly, the management device 10 selectively uses the first and second startup methods for each bus network, depending on the function to be enabled, to start the target device. This achieves both a reduction in power consumption and a quick startup. However, in a case in which modifications have been made to the vehicle on-board network system 100, which includes the management device 10, the same startup method as that used before the modifications is unlikely to achieve both a reduction in power consumption and a quick startup.

The modifications made to the vehicle on-board network system 100 include an increase or decrease in the number of the devices connected to the vehicle on-board network system 100. For example, there is a case in which an ECU connected to a certain bus network is added. In this case, the power consumed to start the target device connected to that bus network using the first startup method is increased by an amount corresponding to the added ECU.

The modifications made to the vehicle on-board network system 100 include software updates in a vehicle that includes the vehicle on-board network system 100. For example, there is a case in which the software for a vehicle is updated so that a change occurs in the target device to be started for a certain function or in the number of target devices to be started. This results in a change in the power consumption when the target device is started for that function using the first startup method.

The modifications made to the vehicle on-board network system 100 include the rearrangement of the devices connected to the vehicle on-board network system 100. For example, when the positions of the first ECU 21 and the sixth ECU 26 are rearranged to exchange their locations, regarding the function that uses the first ECU 21 and does not use the sixth ECU 26, the number of target devices to be started decreases in the first bus network 61. The number of target devices to be started increases in the second bus network 62.

In this manner, modifications may be made to the vehicle on-board network system 100. Even in such a case, to achieve both a reduction in power consumption and a quick startup, the management device 10 selectively uses the startup method for the target device in correspondence with the modified vehicle on-board network system 100.

### Flow of Learning Process Executed by Processing Device 11

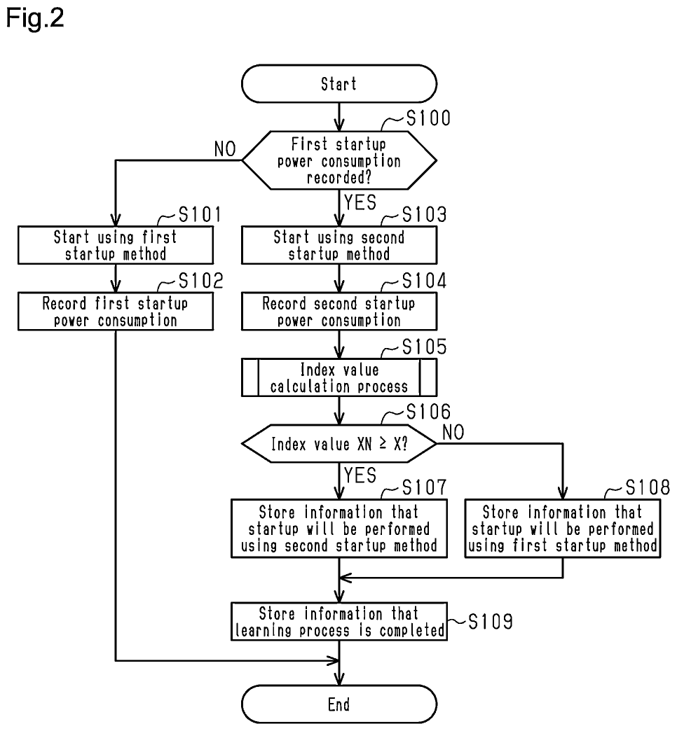

FIG. 2 illustrates the flow of a learning process executed by the processing device 11.

In the learning process, after obtaining information related to the modified vehicle on-board network system 100, the management device 10 reselects the startup method for the target device to learn the startup method for the target device in the modified vehicle on-board network system 100. The learning process allows the management device 10 to adapt to the vehicle on-board network system 100 to which modifications have been made. The management device 10 selects the startup method for each bus network and thus executes the learning process for each bus network as well. The management device 10 does not execute the learning process for the bus network to which no target devices are connected.

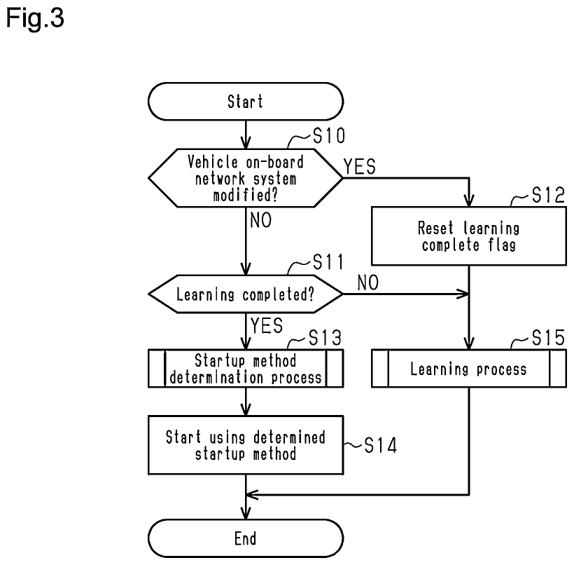

FIG. 3 illustrates the flow of processes related to the startup of the target device executed by the processing device 11. The series of processes in FIG. 3 is executed when the management device 10 receives a request for enabling a predetermined function from another device. The learning process shown in FIG. 2 corresponds to the process of step S15 in FIG. 3. Thus, the series of processes in FIG. 2 is executed when the management device 10 receives a request for enabling the predetermined function from another device and then starts the target device.

First, the flow of the learning process will be described with reference to FIG. 2.

As shown in FIG. 2, upon initiating the series of processes, in the process of step S100, the processing device 11 determines whether the power consumption required when starting the target devices on the bus network using the first startup method has been recorded. In this state, the processing device 11 determines whether it has executed the process of step S102. As will be described later, in the process of step S102, the processing device 11 causes the storage device 12 to record the power consumption required for startup using the first startup method. Thus, in the process of step S100, the processing device 11 determines whether the power consumption required for startup using the first startup method has been recorded in the storage device 12. In the following description, the power consumption required for startup using the first startup method may be referred to as the first startup power consumption.

When determining that the first startup power consumption has not been recorded (step S100: NO), the processing device 11 advances the process to step S101. In the process of step S101, the processing device 11 starts the target device on the bus network using the first startup method. In other words, when the management device 10 starts the target device in correspondence with a signal requesting the enabling of a predetermined function, the processing device 11 starts the target device using the first startup method regardless of the startup method used for the bus network in the vehicle on-board network system 100 to which modifications have not been made. Thereafter, the processing device 11 advances the process to step S102.

In the process of step S102, the processing device 11 records the first startup power consumption.

For example, the management device 10 stores the power consumed when starting each ECU in the vehicle on-board network system 100. As described above, each ECU sends a signal indicating that it has been started during the startup. The processing device 11 identifies the started ECU based on such a signal. The processing device 11 can obtain the first startup power consumption by summing the power consumed at the startup of each ECU.

When the power consumption of the ECUs is uniform, the processing device 11 may obtain the first startup power consumption based on the number of ECUs that have been started on the bus network. In this case, the processing device 11 identifies the number of started ECUs by counting the number of signals that is sent by the ECUs and indicates that the ECUs have been started. The processing device 11 can obtain the first startup power consumption by multiplying the power consumed by one ECU during startup by the number of ECUs that have been started up.

The processing device 11 may obtain the first startup power consumption by receiving the power consumption required for startup from the ECU that has been started up on the bus network. In this case, during startup of the ECU, the ECU sends, to the management device 10, a signal indicating that it has been started and information related to the power consumed by starting the ECU. Based on such information received from the ECU, the processing device 11 can determine the first startup power consumption by summing the power consumed by the ECUs on the bus network.

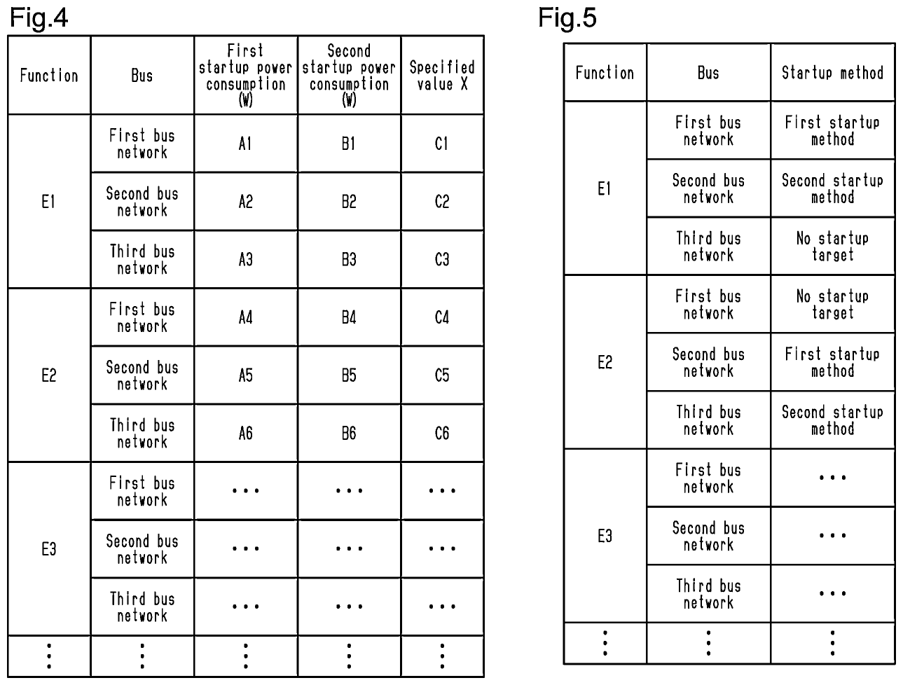

In this manner, after obtaining the first startup power consumption, the processing device 11 records the power consumption by storing the obtained power consumption in the storage device 12. The table shown in FIG. 4 describes the first startup power consumption recorded by the processing device 11 through the process of step S102. As previously mentioned, the series of processes shown in FIG. 2 is executed for each bus network. Thus, as shown in FIG. 4, the management device 10 records the first startup power consumption on each bus network for one function executed by the management device 10. In FIG. 4, multiple distinct functions are labeled as E1, E2, E3, and continue in this manner. In FIG. 4, the first startup power consumption obtained in the process of step S101 is also labeled as A1, A2, A3, and continue in this manner.

After recording the first startup power consumption, the processing device 11 ends the series of processes.

When determining that the first startup power consumption has been recorded (step S100: YES), the processing device 11 advances the process to step S103. In the process of step S103, the processing device 11 starts the target device on the bus network using the second startup method. In other words, when the management device 10 starts the target device in correspondence with a signal requesting the enabling of a predetermined function, the processing device 11 starts the target device using the second startup method regardless of the startup method used for the bus network in the vehicle on-board network system 100 to which the modifications have not been made. Thereafter, the processing device 11 advances the process to step S104.

In the process of step S104, the processing device 11 records the power consumption required when starting the target devices on the bus network using the second startup method. The method for obtaining the power consumption required when starting the target devices on the bus network using the second startup method and the method for recording that power consumption are the same as those executed in the process of the above-described step S102. In the following description, the power consumption required for startup using the second startup method may be referred to as the second startup power consumption.

The table shown in FIG. 4 also describes the second startup power consumption recorded by the processing device 11 through the process of step S104. In FIG. 4, the second startup power consumption obtained in the process of step S104 is also labeled as B1, B2, B3, and continue in this manner. When the target device is started using the second startup method, the number of ECUs to be started on the bus network does not increase as compared with when the target device is started using the first startup method. Thus, for the same bus network, the first startup power consumption is greater than or equal to the second startup power consumption. For example, in FIG. 4, A1 is never smaller than B1.

In the process of the next step S105, the processing device 11 performs an index value calculation process. The index value is calculated for comparing the first startup power consumption with the second startup power consumption. Hereinafter, in the present embodiment, the index value is denoted by XN.

In the process of step S105, the processing device 11 calculates the index value XN using the following equation.

$$XN = \frac{( First startup power consumption ) - ( Second startup power consumption )}{( First startup power consumption )} \times 100$$

As shown in the above-described equation, the processing device 11 calculates, as the index value XN, the proportion of the difference between the first startup power consumption and the second startup power consumption relative to the first startup power consumption.

In the process of the next step S106, the processing device 11 determines whether the index value XN calculated in the process of step S105 is greater than or equal to a specified value. Hereinafter, in the present embodiment, the specified value is denoted by X. The larger the index value XN, the smaller the second startup power consumption is compared to the first startup power consumption. The specified value X is a threshold value used to determine that power consumption can be reduced by selecting the second startup method based on the index value XN being greater than or equal to the specified value X.

In FIG. 4, the specified value X is labeled as C1, C2, C3, and continue in this manner. The specified value X may be set to a different value for each bus network, even if the same function is executed. The specified value X may be set to a different value depending on the function to be executed, even if the same bus network is used.

When determining that the index value XN is greater than or equal to the specified value X (step S106: YES), the processing device 11 advances the process to step S107. In the process of step S107, the processing device 11 stores, in the storage device 12, information that the target devices connected to the bus network in which the index value XN is greater than or equal to the specified value X will be started using the second startup method. That is, the processing device 11 selects the second startup method as the startup method from the first and second startup methods.

When determining that the index value XN is less than the specified value X (step S106: NO), the processing device 11 advances the process to step S108. In the process of step S108, the processing device 11 stores, in the storage device 12, information that the target devices connected to the bus network in which the index value XN is less than the specified value X will be started using the first startup method. That is, the processing device 11 selects the first startup method as the startup method from the first and second startup methods.

The table shown in FIG. 5 illustrates an example of the startup methods stored in the storage device 12 by the processing device 11 in the processes of step S107 and step S108. For the functions to be executed by the management device 10, the processing device 11 selects the startup method for the target device on each bus network. The processing device 11, as shown in FIG. 5, learns the startup method for the target device in the vehicle on-board network system 100 by storing, in the storage device 12, the startup method for the target device for each bus network in the functions.

After executing the process of step S107 or the process of step S108, the processing device 11 advances the process to step S109. In the process of step S109, the processing device 11 stores, in the storage device 12, information that the learning process is completed. Specifically, the flag in the storage device 12 is switched from a state in which the learning process is not completed to a state where the learning process is completed. After executing the process of step S109, the processing device 11 ends the series of processes.

### Flow of Processes Executed by Processing Device 11 to Start Target Device

As described above, FIG. 3 illustrates the flow of processes related to the startup of the target device executed by the processing device 11. The series of processes is executed when the management device 10 receives a request for enabling a predetermined function from another device. Thus, the processing device 11 executes the series of processes for each function executed by the management device 10.

Upon initiating the series of processes, the processing device 11 determines in the process of step S10 whether any modifications have been made to the vehicle on-board network system 100. Modifications made to the vehicle on-board network system 100 affect the execution of functions by the management device 10. Thus, when modifications are made to the vehicle on-board network system 100, the programs stored in the storage device 12 are updated or similarly modified. The processing device 11 determines in the process of step S10 whether such an event, notifying that modifications have been made to the vehicle on-board network system 100, ahs occurred.

When determining that modifications have been made to the vehicle on-board network system 100 (step S10: YES), the processing device 11 proceeds to step S12. In the process of step S12, the processing device 11 resets the learning complete flag. The processing device 11 switches the flag to indicate that the learning process is completed in the process of step S109 of FIG. 2. In the process of step S12, the processing device 11 resets this flag to indicate that the learning process is incomplete. This flag is reset for each function. After resetting the learning complete flag, the processing device 11 advances the process to step S15.

When determining that no modifications have been made to the vehicle on-board network system 100 (step S10: NO), the processing device 11 proceeds to step S11. In the process of step S11, the processing device 11 determines whether the learning is completed. The processing device 11 determines whether the learning process is completed based on whether the flag indicates that the learning process is completed.

When determining that the learning is incomplete (step S11: NO), the processing device 11 advances the process to step S15.

In the process of step S15, the processing device 11 executes the learning process shown in FIG. 2, as described above. After executing the learning process in the process of step S15, the processing device 11 ends the series of processes.

When determining that the learning is completed (step S11: YES), the processing device 11 advances the process to step S13. In the process of step S13, the processing device 11 executes a startup method determination process. The startup method determination process determines the startup method for the target device on each bus network based on the results, as shown in FIG. 5, learned in the processes of step S107 and step S108 in FIG. 2.

In the next step S14, the processing device 11 starts the target device using the startup method determined in the process of step S13. After starting the target device, the processing device 11 ends the series of processes.

### Operation of Present Embodiment

In a case in which modifications have been made to the vehicle on-board network system 100, in the vehicle on-board network system 100, the management device 10 obtains information related to each of the first startup power consumption and the second startup power consumption. The management device 10 selects the startup method for the target device from the information related to the first and second startup power consumption.

### Advantages of Present Embodiment

(1) The management device 10 can select the startup method for the target device in consideration of the difference between the first startup power consumption and the second startup power consumption in the vehicle on-board network system 100 subsequent to being modified. This allows the management device 10 to reselect the startup method for the target device in a case in which modifications have been made to the vehicle on-board network system 100.
(2) When obtaining information, the management device 10 calculates the proportion of the difference between the first startup power consumption and the second startup power consumption relative to the first startup power consumption. When selecting the startup method for the target device, the management device 10 selects the second startup method in a case in which the calculated proportion is greater than or equal to the specified value. When selecting the startup method for the target device, the management device 10 selects the first startup method in a case in which the calculated proportion is less than the specified value.

The first startup method allows the target device to start quickly, but consumes a relatively high power consumption. The second startup method consumes less power to start the target device than the first startup method, but it takes more time to start. The larger the proportion of the difference between the first startup power consumption and the second startup power consumption relative to the first startup power consumption, the larger the power consumption that can be reduced when the second startup method is used. When that proportion is relatively small, using the second startup method results in less reduction in power consumption and longer startup times for the target devices.

The management device 10 compares the specified value X with the proportion of the difference between the first startup power consumption and the second startup power consumption relative to the first startup power consumption, thereby selecting the startup method for the target device. Even if modifications have been made to the vehicle on-board network system 100, the above configuration allows the management device 10 to select a startup method that achieves both a reduction in power consumption and a quick startup.
(3) The vehicle on-board network system 100 includes multiple bus networks connected to the management device 10. The power control line that starts the target device using the first startup method is provided for each bus network. The management device 10 obtains information for each bus network to select the startup method for the target device on each bus network.

When a large number of target devices need to be started when a vehicle executes a certain function, the difference between the first startup power consumption and the second startup power consumption is relatively small. Thus, the startup method for the target device that is optimal for the entire vehicle on-board network system 100 is the first startup method.

However, the bus networks in the vehicle on-board network system 100 may include a bus network that does not have a target device corresponding to the above-described function. The bus networks in the vehicle on-board network system 100 may include a bus network in which only a small number of ECUs connected to the bus network are target devices. The target device connected to such bus networks is preferably started using the second startup method. Thus, the startup method that is optimal for the entire vehicle on-board network system 100 may not be optimal for each bus network.

The management device 10 selects the startup method for the target device on each bus network in the vehicle on-board network system 100. This enables the management device 10 to start ECUs while achieving both a reduction in power consumption and a quick startup in a well-balanced manner.

### Modifications

The present embodiment may be modified as follows. The present embodiment and the following modifications can be combined as long as they remain technically consistent with each other.

In the above-described embodiment, multiple ECUs in the vehicle on-board network system 100 are connected to each other via the first communication line 41, the second communication line 42, and the third communication line 43 such that the units can communicate with each other. Instead, the ECUs in the vehicle on-board network system 100 may be connected to each other via wireless communication such that they can communicate with each other. In this case, the management device 10 starts a target device using the second startup method through wireless communication, without using the first communication line 41, the second communication line 42, or the third communication line 43.

In the above-described embodiment, the management device 10 obtains, for each bus network, information related to the power consumption required for startup using each startup method. The management device 10 selects the startup method for the target device on each bus network. However, the management device 10 does not have to obtain information and select the startup method for each bus network as described above. For example, the management device 10 may collectively obtain information and select the startup method for all ECUs connected to the management device 10. In this case, for example, the management device 10 may use the same startup method for all the ECUs connected to the management device 10 to obtain information related to the power consumption required for startup using each startup method and select the startup method based on that data.

In the above-described embodiment, the management device 10 executes the first and second startup methods once each, thereby obtaining information related to the power consumption required for startup using each startup method. If the management device 10 executes the first and second startup methods once each, it may execute each startup method any number of times in order to obtain the power consumption.

In the above-described embodiment, the management device 10 executes both the first and second startup methods in this order, thereby obtaining information related to the power consumption required for startup using each startup method. In this case, the processing device 11 starts the target device using the first startup method in the process of step S101 in FIG. 2, and then starts the target device using the second startup method in the process of step S103 in FIG. 2. The processing device 11 may execute the first and second startup methods in reverse order.

In the above-described embodiment, the management device 10 calculates, as the index value XN, the proportion of the difference between the first startup power consumption and the second startup power consumption relative to the first startup power consumption. Instead, the management device 10 may calculate the difference between the first startup power consumption and the second startup power consumption as the index value XN.

In this case, when obtaining the information, the management device 10 calculates the difference between the first startup power consumption and the second startup power consumption. When selecting the startup method for the target device, the management device 10 selects the second startup method in a case in which the calculated difference is greater than or equal to the specified value. When selecting the startup method for the target device, the management device 10 selects the first startup method in a case in which the calculated difference is less than the specified value.

The larger the difference between the first startup power consumption and the second startup power consumption, the larger the power consumption that can be reduced when the second startup method is used. When the difference between the first startup power consumption and the second startup power consumption is relatively small, using the second startup method results in less reduction in power consumption and longer startup times for the target devices.

The management device 10 compares the specified value with the difference between the first startup power consumption and the second startup power consumption, thereby selecting the startup method for the target device. Even if modifications have been made to the vehicle on-board network system 100, the above configuration allows the management device 10 to select a startup method that achieves both a reduction in power consumption and a quick startup.

In the above-described embodiment, the management device 10 calculates, as the index value XN, the proportion of the difference between the first startup power consumption and the second startup power consumption relative to the first startup power consumption. Instead, the management device 10 may calculate the ratio of the second startup power consumption to the first startup power consumption as the index value XN.

When obtaining the information, the management device 10 calculates the ratio of the second startup power consumption to the first startup power consumption. When selecting the startup method for the target device, the management device 10 selects the first startup method in a case in which the calculated ratio is greater than or equal to the specified value. When selecting the startup method for the target device, the management device 10 selects the second startup method in a case in which the calculated ratio is less than the specified value.

The smaller the ratio of the first startup power consumption to the second startup power consumption, the larger the power consumption that can be reduced when the second startup method is used. When that ratio is relatively high, using the second startup method results in less reduction in power consumption and longer startup times for the target devices.

The management device 10 compares the specified value with the ratio of the second startup power consumption to the first startup power consumption, thereby selecting the startup method for the target device. Even if modifications have been made to the vehicle on-board network system 100, the above configuration allows the management device 10 to select a startup method that achieves both a reduction in power consumption and a quick startup.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A management device for a vehicle on-board network system in which devices are connected to each other in a communicable manner, the management device comprising:
processing circuitry configured to start a target device of the devices, the target device being a device that operates in accordance with a predetermined function to be executed, wherein the processing circuitry is configured to:
subsequent to modifications made to the vehicle on-board network system, obtain information including:
a first startup power consumption required when starting the target device, using a first startup method for starting the target device through power control that controls whether to supply power to the target device; and
a second startup power consumption required when starting the target device, using a second startup method for starting the target device by communicating with the target device to request startup for the target device;
based on the obtained information, select a startup method for the target device from the first startup method and the second startup method; and
start the target device using the selected startup method.

2. The management device according to claim 1, wherein
the processing circuitry is configured to:
calculate a difference between the first startup power consumption and the second startup power consumption;
select the second startup method when the calculated difference is greater than or equal to a specified value; and
select the first startup method when the calculated difference is less than the specified value.

3. The management device according to claim 1, wherein
the processing circuitry is configured to:
calculate a ratio of the second startup power consumption to the first startup power consumption;
select the first startup method when the calculated ratio is greater than or equal to a specified value; and
select the second startup method when the calculated ratio is less than the specified value.

4. The management device according to claim 1, wherein
the processing circuitry is configured to:
calculate a proportion of a difference between the first startup power consumption and the second startup power consumption relative to the first startup power consumption;
select the second startup method when the calculated proportion is greater than or equal to a specified value, and
select the first startup method when the calculated proportion is less than the specified value.

5. The management device according to claim 1, wherein
the vehicle on-board network system includes bus networks that are connected to the management device,
each of the bus networks includes a power control line that starts the target device using the first startup method, and
the processing circuitry is configured to obtain the information for each of the bus networks and select the startup method for each of the bus networks.
